(19) United States
(12) Patent Application Publication
(10) Pub. No.: US 2011/0208545 A1
(43) Pub. Date: Aug. 25, 2011

(54) Portable Device Distraction Reduction System

(76) Inventor: Jeffrey R. Kuester, Atlanta, GA (US)

(21) Appl. No.: 13/034,677

(22) Filed: Feb. 24, 2011

Related U.S. Application Data
(60) Provisional application No. 61/307,840, filed on Feb. 24, 2010.

(51) Int. Cl. G06Q 40/00; H04M 3/00

(52) U.S. Cl. 705/4; 455/418

(57) ABSTRACT

A portable device enters a safety mode of operation in response to velocity of the device exceeding a threshold. In some embodiments, a portable device determines its position at a plurality of times to determine the velocity of the portable device. The determined velocity is compared to a defined threshold velocity to trigger the safety mode of operation.

### CROSS-REFERENCE TO RELATED APPLICATION

This application claims the benefit of U.S. Provisional Application 61/307,840, filed Feb. 24, 2010, which is hereby incorporated by reference herein in its entirety.

### BACKGROUND

While it is widely recognized as dangerous to operate a vehicle while talking, texting or otherwise operating a portable device or interface of a vehicle, drivers continue to operate such devices and interact with vehicle interfaces that distract from driving. Consequently, a system is needed to address at least a portion of those activities.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all known and readily derived alternatives, modifications, and equivalents.

FIG. 1 illustrates a network block diagram in accordance with one implementation, among others.

FIG. 2 is a block diagram of a portable device in accordance with one implementation, among others.

FIG. 3 is a block diagram of memory for the portable device, in accordance with one implementation, among others.

FIG. 4 is a flow chart representation of one process of the present disclosure, among others.

FIG. 5 is a flow chart representation of a safety mode of operation in accordance with one implementation, among others.

### DETAILED DESCRIPTION

A portable device determines whether the device is moving faster than a threshold velocity (e.g., 5 miles per hour) such as by determining distances between global positioning system (GPS) locations travelled within an amount of time, among other methods. Responsive to the determination, the portable device enters a safety mode of operation. In one embodiment, the safety mode of operation includes disabling all or a portion of interaction with the portable device unless a safety override input is received by the portable device. For example, a user may input a password or provide another affirmative input in response to a prompt, such as a voice response to a voice prompt, or a keyboard response to a display prompt, among other techniques for detecting user input, all of which acceptable in various embodiments. One example of a prompt override input combination would simply be an “Are you sure?” (or “Is it safe?”) prompt with an associated single-key input designating “yes” or “no.” Another example implementation includes immediately invoking the general locking/unlocking operation of the portable device that, in some embodiments, would otherwise be invoked after a configurable period of non-use. In some embodiments, regular operation resumes after a safety override input is received, with no (or reduced) operation being possible otherwise. In other embodiments, a reduced mode of operation is invoked upon receipt of the safety override input, with no operation being possible otherwise.

In other embodiments, interaction with the portable device is limited during the safety mode of operation, with some embodiments requiring a safety override before that limited operation is available, and other embodiments requiring no safety override before entering the limited mode of operation. One example (with all uses of the word “example” to be understood herein to be among other acceptable examples) of a limited operation mode includes requiring all interaction with the portable device to be through voice-controlled operations (i.e., audible prompts and microphone detected inputs), and preferably without (though not necessary in all implementations) any visual screen output. For example, an audible voice from the device announces that because the device is moving, voice interaction is necessary.

Some embodiments include displaying alternate, easier-to-use, interface screens, e.g., touch screens showing larger or fewer buttons, etc. Other implementations include disabling some operations and/or applications of the portable device, such as disabling all or a portion of the text messaging and email communication capabilities (but leaving map/traffic capabilities fully operational, for example). Other implementations include disabling all communication capabilities except for emergency telephone calls or incoming telephone calls, though voice interaction may be required for one or both of those types of calls in some embodiments. Other implementations include functionality for designating contacts stored in the portable device as authorized to automatically override safety mode operations when incoming communications (selectably including, in some implementations, telephone, sms, email, etc.) are received from those contacts, i.e., when a parent calls a child, the telephone will ring and be available, through normal operations in some embodiments, and in voice-only operations in others. In some implementations in which the portable device outputs music or other audio or video signals to a separate device, such output would continue during the safety mode of operation.

Some embodiments include one or more auto-response functions. For example, a portable device and/or server/provider system effects the transmission of an alternate voicemail announcement while the portable device is travelling at a velocity greater than a threshold, e.g., “the person you called is currently in a moving vehicle, so please leave a message.” The voicemail announcement is preferably prompted immediately, with preferably no ringing or vibrating (or other indication) of the portable device, and a regular message waiting indication is made to the user after a voicemail message is recorded. In some implementations, the message waiting indication is not made until a safety mode of operation ends. In other embodiments, an auto-response function includes automatically sending responsive text messages and/or email messages that indicate the user is currently in a moving vehicle and not responding to messages. Likewise, indications to the user of one or more received messages are provided to the user after velocity of the portable device falls below a threshold. Yet other embodiments include limiting interaction to a set number of keystrokes, a number of messages (text messages, email messages, etc.), or a time delay until further operation is prevented. In other words, after a threshold velocity is reached, a user may have only a set number of keystrokes, messages, or time remaining before the portable device suspends functions until the portable device velocity again falls below a threshold.

In some embodiments, the steps of velocity determination and threshold comparison occur continually, (e.g., comparison to a threshold multiple times per second, once per second, once per 2 seconds, once per 5 seconds, etc.) regardless of the whether or not the portable device is operating in a safety mode of operation. However, in some embodiments, the steps occur with greater frequency during the safety mode of operation. Other embodiments include applying a different velocity threshold during the safety mode of operation. For example, in some implementations, hysteresis is prevented through applying different thresholds. Regardless of the frequency of such steps and any change of that frequency during different modes of operation, cessation of the safety mode of operation preferably occurs when the velocity of the portable is determined to be below the threshold. In some embodiments, cessation of the safety mode of operation results in the portable device resuming activity with the same screen it was displaying when the safety mode was initiated. Thus, for example, if the user was in the middle of composing a text message or an email message when the safety mode of operation was invoked, resulting in the screen going blank and portable device being put in a hold state, the user is able to resume composing the message after the velocity of portable device falls below a threshold such that the safety mode of operation ceases.

In yet other embodiments, responsive to a determination that the portable device is being operated by a user while the portable device is moving faster than a threshold velocity, a notification message (e.g., text message, email message, voice message, etc.) is transmitted to a previously designated destination, e.g., a telephone number or an email address, among others. In some embodiments in which users are provided one or more safety override options as discussed above, the notification messages are sent after a user initiates the safety override. Some safety overrides may simply be any additional input after a notice is displayed to a user that a notification message is going to be sent if further input is received. Other embodiments do not include any prompts or safety overrides and simply automatically send the notification message when the portable device is being operated while moving faster than the threshold velocity. Such embodiments include embodiments where selected (predefined or user-selected, according to different embodiments) operations will automatically trigger the notification messages, while other embodiments will trigger notification messages based upon detection of any type of operation/activity by the user, and other embodiments trigger the notification messages based upon a certain amount of activity, such as a duration of activity or a total number of received inputs, etc. The notification message preferably provides some type of indication of the identity of the portable device since multiple portable devices may be configured to send notification messages to the same destination. Other implementations include the portable device creating a log within the portable device of each time a user invokes a safety override or uses the portable device while moving faster than a threshold speed, and as with other functions described herein, this function stands alone in some implementations and is combined with the messaging function and/or other functions in other implementations. This logging function is particularly useful, though not limited to, devices not having cellular or other relatively continuous communications capabilities, e.g., devices depending on communication through WiFi or other wireless local networks. Batch communication of the log is also provided in some implementations, e.g., an email message is communicated once per week that lists out the dates and times of the safety overrides for a particular device. Of course, other timeframes are included in other implementations.

In some implementations, the functions described herein are invoked as part of a software download, or “application”, for a portable device. In other words, a user purchases or otherwise obtains an add-on application that enables a portable device to provide the functions discussed herein. In some examples, such an application is downloaded through a wired or wireless connection with one or more providers of applications for the portable device. Other embodiments include providing one or more of the functions described herein as basic embedded functions within the portable device that are already installed when the device is purchased by a user. For example, without limitation, the functions described herein are part of text messaging and email applications in some embodiments and part of operating systems to override virtually all portable device functions in other embodiments.

Initial configuration and activation of one or more of the functions discussed herein may be performed by a parent on a portable device normally operated by a teenage child. Consequently, some embodiments operate in a stealth mode of operation, and user configuration functions are protected and/or hidden by an independent, parental password. In some embodiments, the stealth mode of operation includes leaving no detectable indication in the portable device that a notification message has been sent regarding use of the portable device while the device is travelling above a velocity threshold. Thus, there would be no visible difference in the operation of the device for the teenage child. For example, there would be no “are you sure” display or prompt to the user in some examples, and/or in other examples, if a text notification message is sent, use of the text message function would not reveal any record on the portable device of a text message being sent from the portable device. In addition, a special key combination is necessary in some embodiments in order to access or find a configuration screen. Other embodiments include automatic generation and transmission of a configuration change message whenever any settings are changed. In some embodiments, settings for the safety mode functions (including, for example among others, a text messaging notification message recipient telephone number, an email notification message recipient email address, etc.) are available through a centralized settings interface where settings for other portable device functions are accessed.

Furthermore, various embodiments include providing configuration screens on the portable device that include settings for enabling and configuring one or more of the functions disclosed herein. For example, in one embodiment, a user engaging in a configuration process is presented a configuration screen that includes, among other items, a prompt and an entry location for a telephone number to which text notification messages will be sent (and/or other notification recipient address information to which other types of notification messages will be sent). In some embodiments all of the available functions are selectable and configurable by a user, while other embodiments make only a portion of the functions selectable or configurable. Alternatively, configuration of the portable device is handled through a computer that communicates directly (wired or wireless) or indirectly (through a browser interface to one or more servers that communicate through an Internet connection) with the portable device. Thus, in one implementation, software providing other configuration and interface functions is used to configure one or more of the functions of the present disclosure. Alternatively, dedicated software on a computer provides the user interface for configuring the functions of the present disclosure. In some embodiments, no interaction with the portable device is required to push and install on the portable device software providing the disclosed functions. For example, a website and supporting software and web server hardware are provided in some embodiments through which users may input a portable device telephone number, or other device identification for the portable device to be monitored, along with notification message recipient information, such as a mobile telephone number, email address, etc.

Since use of a portable device equipped with one or more of the presently disclosed features should result in safer driving, it is contemplated that automobile insurance companies would charge a lower premium for insuring such automobiles. Consequently, it will be useful in some embodiments to periodically verify the use of safety modes of operation through communications (which are authenticated in some embodiments) from the portable device to an interested recipient, such as an insurance company server, among other types of interested recipients. Thus, some embodiments include additional capabilities for periodically communicating status information to monitoring recipients, wherein the status information of course includes information that can be used to identify the user of the portable device or an insurance account associated with the user. In addition to insurance companies and other types of entities, such as employers of people who drive as part of their employment, parents of teenagers and other interested monitors receive status messages or other electronic communications confirming proper operation of one or more of the functions disclosed herein, in accordance with some embodiments. Such messages include email messages, text messages, as well as other types of communications that provide confirmation of proper operation. In some embodiments, determination of proper operation includes, among others, evaluation of GPS or other location determination availability, and status communications include confirmation of such availability in some embodiments. Other embodiments includes communications that enable a determination of the length of time of continuous operation, amount of time since last operation was confirmed, reasons for outages in operation, etc.

In some embodiments, one or more servers perform all or part of the steps of the present disclosure. For example, there are a variety of methods of determining location information for a portable device. Any of those methods could be used by one or more computer servers for velocity determination and threshold comparison in order to invoke a safety mode of operation in the portable device through communication with the portable device.

References to portable devices and operations thereof should also be understood to be applicable to devices and interfaces forming part of a vehicle. In other words, it is understood that the above described functions of portable devices can likewise be performed by an installed GPS system or other installed vehicular system that could otherwise draw a user's visual or mental attention away from driving the vehicle. In addition, in some embodiments, detection of movement of the portable device with a velocity above a threshold includes a minimum location change, e.g., 10 feet, and/or a delay mechanism that require velocity to be above a threshold for a defined amount of time, e.g., 2 seconds. Of course, embodiments are included within the scope of the present disclosure that do not include such minimum location changes or delay mechanisms. In addition, uses herein of the words “preferred”, “preferably” and “some,” among others, indicate that other embodiments and implementations are included with the scope of the present disclosure that do not include the elements or functions associated with such words.

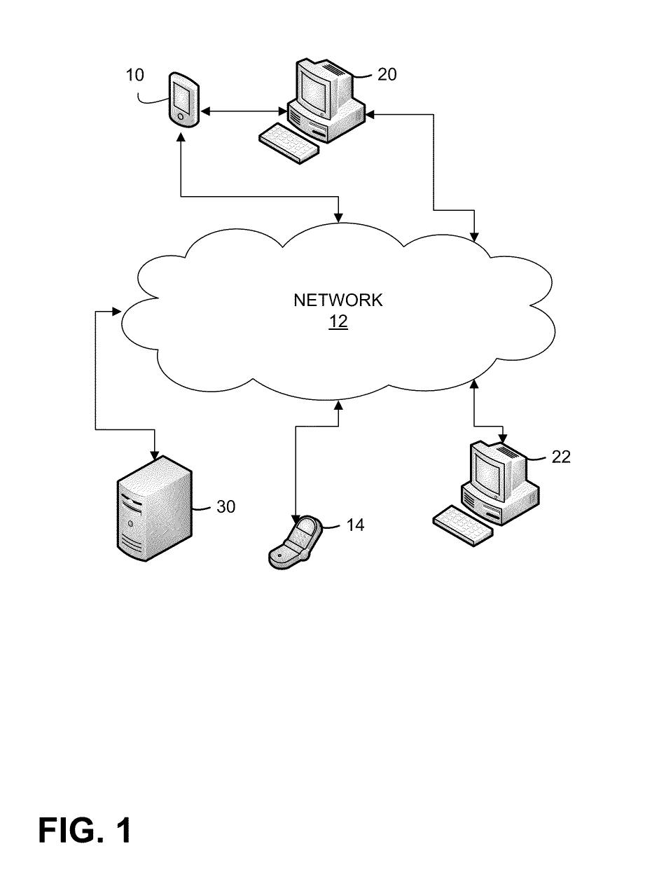

FIG. 1 is a network diagram showing a portable device 10 connected to a network 12 that is also connected to another portable device 14, a computer 20 (which is also independently connected to the portable device 10), another computer 22, and a server 30. The elements shown in FIG. 1 are representative of a plurality of similar elements. As indicated above, one example of portable device 10 is a smart cellular telephone, with one implementation being an iPhone from Apple, Inc., with modifications consistent with the functions disclosed herein. Consequently, in one example, the connection to network 12 includes a conventional cellular (data and telephony) connection and, if available, a conventional WiFi connection through a WiFi router in network 12, while the occasional connection to computer 20 is a conventional wired USB connection. The computer 20 preferably runs an interface application, such as iTunes from Apple, Inc., that provides a synchronizing user interface for backing up information on the portable device 10 and providing other configuration functionality for the portable device 10, such as installation of new operating software, configuration of software applications, among others. Consequently, computer 20, representative of all types of personal computers and other computing devices, communicates with server 30 to receive information for communication to portable device 10. Of course, other embodiments include other types of portable devices, as well as other type of wired and wireless connections to network 12 and computer 20, with some embodiments not including computer 20.

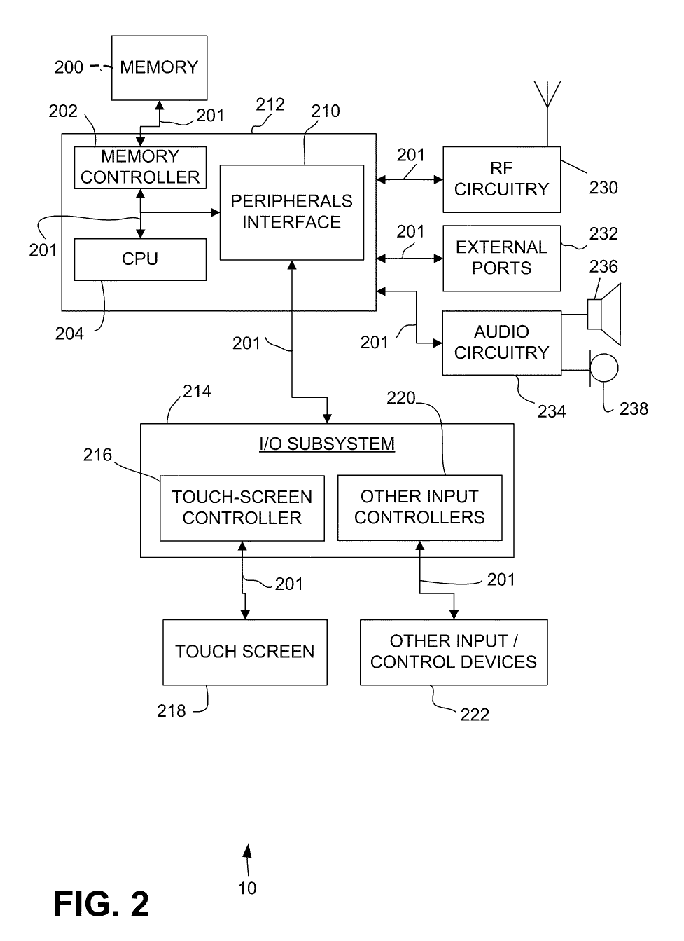

Referring also now to FIG. 2, according to some embodiments, portable device 10 includes a memory 200, a memory controller 202, one or more processing units (CPU's) 204, a peripherals interface 210, RF circuitry 230, audio circuitry 234, a speaker 236, a microphone 238, input/output (I/O) subsystem 214 with a touch-screen controller 216 connected to a touch screen 218 and other input controllers 220 connected to other input/control devices 222, such as physical buttons (e.g., push buttons, rocker buttons, etc.), dials, slider switches, sticks, etc. External ports 232 provide for connections to external devices, such as computer 20 in FIG. 1. These various components communicate over the one or more communication buses or signal lines 201. As discussed above, portable device 10 can be any portable electronic device, including but not limited to a handheld computer, a tablet computer, a mobile phone, a media player, a personal digital assistant (PDA), among others, including a combination of two or more of these items. In various embodiments, the various components shown in FIG. 2 are implemented in hardware, software or a combination of both hardware and software, including one or more signal processing and/or application specific integrated circuits.

Memory 200 may include, among others, high speed random access memory and may also include non-volatile memory, such as one or more magnetic disk storage devices, flash memory devices, or other non-volatile solid state memory devices. Access to the memory 200 by other components of the portable device 10, such as the CPU 204 and the peripherals interface 210, may be controlled by the memory controller 202. The peripherals interface 210 couples the input and output peripherals of the portable device 10 to the CPU 204 and the memory 200. The CPU 204 runs various software programs and/or sets of instructions stored in the memory 200 to perform various functions for the portable device 10 and to process data. In some embodiments, the peripherals interface 210, the CPU 204, and the memory controller 202 are implemented on a single chip 212, while in other embodiments, they are implemented on separate chips.

The RF (radio frequency) circuitry 230 receives and sends electromagnetic waves, converting electrical signals to/from electromagnetic waves to communicate through network 12 and with other communications devices via the electromagnetic waves. The RF circuitry 230 preferably includes understood circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 230 communicates with network 12, such as the Internet, an Intranet and/or a wireless network, such as a cellular telephone network, a wireless local area network (LAN) and/or a metropolitan area network (MAN), and other devices by wireless communication. The wireless communications preferably encompass a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n, etc.), voice over Internet Protocol (VoIP), Wi-MAX, a protocol for email, instant messaging, and/or Short Message Service (SMS)), or any other suitable communication protocol. The RF circuitry 230 also preferably includes a GPS receiver for receiving global positioning system signals from orbiting satellites to determine a location of the portable device 10. Of course, the GPS receiver is located elsewhere within portable device 10 in other embodiments, and yet other embodiments include alternative mechanisms for determining locations of the portable device 10.

The audio circuitry 234, the speaker 236, and the microphone 238 provide an audio interface between a user and the portable device 10. The audio circuitry 234 receives audio data from the peripherals interface 210, converts the audio data to an electrical signal, and transmits the electrical signal to the speaker 236, which converts the electrical signal to sound waves. The audio circuitry 234 also receives electrical signals converted by the microphone 238 from sound waves. The audio circuitry 234 converts the electrical signal to audio data and transmits the audio data to the peripherals interface 210 for processing. Audio data may be retrieved from and/or transmitted to the memory 200 and/or the RF circuitry 230 by the peripherals interface 210. In some embodiments, the audio circuitry 234 also includes a headset jack (not shown) providing an interface between the audio circuitry 234 and removable audio input/output peripherals, such as output-only headphones or a headset with both output (headphone for one or both ears) and input (microphone).

The I/O subsystem 214 provides the interface between input/output peripherals on the portable device 10, such as the touch screen 218 and other input/control devices 222, and the peripherals interface 210. The I/O subsystem 214 includes a touch-screen controller 216 and one or more input controllers 220 for other input or control devices. The one or more input controllers 220 receive/send electrical signals from/to other input/control devices 222. In one implementation, other input/control devices 222 include at least one physical button, while other implementations include dials, slider switches, sticks, roller balls, etc. The touch screen 218 provides both an output interface and an input interface between the device and a user. The touch-screen controller 216 receives/sends electrical signals from/to the touch screen 218, which displays visual output to the user. The visual output preferably includes text, graphics, video, and any combination thereof. The touch screen 218 forms a touch-sensitive surface that accepts user input. The portable device 10 also includes a power system (not shown) for powering the various components.

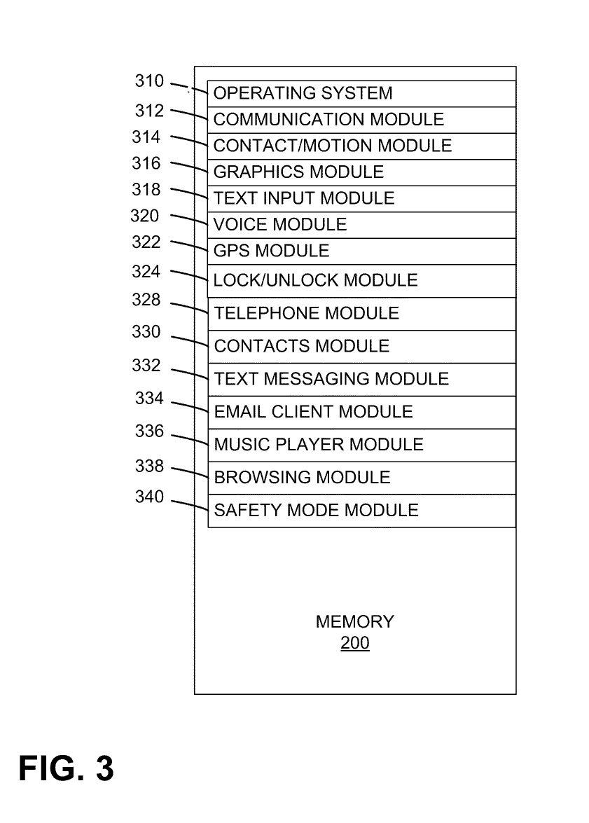

With continuing reference to FIGS. 1 and 2, refer also now to FIG. 3, which shows a block diagram of memory 200, in accordance with one implementation, among others. In some embodiments, software components of memory 200 include, among others, an operating system 310, a communication module 312, a contact/motion module 314, a graphics module 316, a text input module 318, a voice module 320, a GPS module 322, a lock/unlock module 324, a telephone module 328, a contacts module 330, a text messaging module 332, an email client module 334, a music player module 336, a browsing module 338, and a safety mode module 340. Of course, each of the modules, or applications, discussed herein preferably correspond to a set of instructions to be executed by a machine such as the processor 204, for performing one or more of the functions described. These modules, applications or instructions need not be implemented as separate programs, but rather may be combined or otherwise rearranged in various combinations. Furthermore, other embodiments are also included that do not execute instructions or utilize instructions. In addition, in some embodiments, modules are downloadable to the portable device 10 by a user, while in other embodiments, all of the features are standard features provided immediately upon purchase of the portable device 10. In one implementation, the safety mode module 340 is available to be downloaded (and upgraded) by a user, while in other implementations, the safety mode module 340 is integrated in the portable device 10 without requiring user downloading.

The operating system 310 (e.g., Darwin, RTXC, LINUX, UNIX, OS X, WINDOWS, or an embedded operating system such as VxWorks, among others) includes various software components and/or drivers for controlling and managing general system tasks (e.g., memory management, storage device control, power management, etc.) and facilitates communication between various hardware and software components. The communication module 310 facilitates communication with other devices over one or more external ports 232 and also includes various software components for handling data received by the RF circuitry 230 and/or the external ports 232. The external ports 232 (e.g., Universal Serial Bus (USB), FIREWIRE, etc.) is adapted for coupling directly to other devices or indirectly over a network (e.g., the Internet, wireless LAN, etc.). The contact/motion module 314 detects different types of contact and contact motion with the touch screen 218, in conjunction with the touch-screen controller 216. The graphics module 316 includes various understood software components for rendering and displaying graphics on the touch screen 218, with “graphics” includes any object that can be displayed to a user, including without limitation, text, web pages, icons (such as user-interface objects including soft keys), digital images, videos, animations and the like. The text input module 318 provides soft keyboards or keypads for entering letters and numbers, for example, for use by various modules, e.g., the contacts module 330 (address book updating), text messaging module 332 (composing a text (SMS) message), email client module 334 (composing an email message), browsing module 338 (typing in a web site universal resource locator), and telephone module 328 (for managing a wireless telephone call communications session between the portable device 10 itself and other telephone devices, including other portable multifunction devices or other conventional telephones). Voice module 318 likewise provides an interface with other modules to provide for voice control of portable device 10, selecting, generating and sending out audio prompt and feedback information through peripherals interface 210, audio circuitry 234, and speaker 236, as well as interpreting audio signals received through peripherals interface 210 from audio circuitry 234 and microphone 238.

The GPS module 322, in conjunction with a GPS receiver in RF circuitry 230, determines or computes the current geographic location of the portable device 10 and provides this information for display or use by other modules that provide location-based services, such as the safety mode module 340, or a map/navigation module (not shown). In some embodiments, the GPS module 322 also computes velocity and provides such information to other modules. The lock/unlock module 324 detects satisfaction of any of one or more user-definable conditions to transition the portable device 10 to a user-interface lock state and to transition the portable device 10 to a lock state. For example, among other causes, if there is no interaction with the portable device 10 for at least a time period defined by a user through a user settings screen, an auto-lock occurs to automatically transition the portable device 10 into a locked state such that future interaction with the portable device 10 requires a user to enter a defined password (or passcode). The telephone module 328 provides telephony functionality for the portable device 10, utilizing the peripherals interface 210, audio circuitry 234, speaker 236, and microphone 238. Similarly, the contacts module 330 provides a user interface to stored contact information (e.g., telephone numbers, mailing addresses, email addresses, etc.), among other features. The text messaging module 332 and the email client module 334 likewise provide text messaging (SMS) and email functions to the user of device 10. The music player module 336 preferably manages and outputs audio and audio/video information downloaded to portable device 10 for playing through speaker 236 or other external output through external ports 232. The browsing module 338 provides web browsing functions to the user.

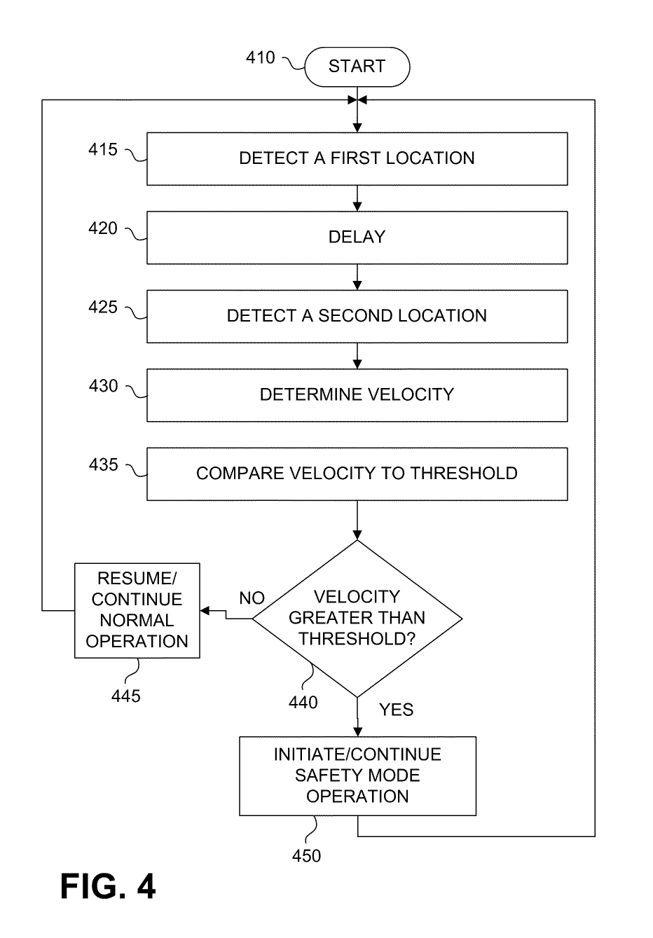

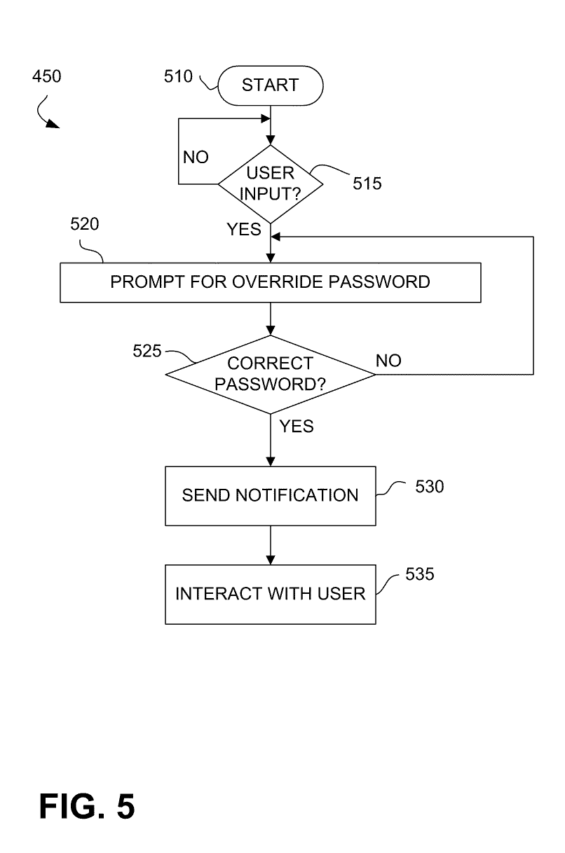

The safety mode module 340 preferably receives location information from GPS module 322 in order to determine whether to initiate a safety mode of operation in portable device 10, as discussed above in various embodiments and explained further in association with the embodiments illustrated in FIGS. 4 & 5, which will now be referenced. After starting in step 410, the process shown in FIG. 4 includes the GPS module 322 detecting a first location in step 415, followed by a defined delay in step 420, after which a second location is determined by GPS module 322 in step 425. In some embodiments, the safety mode module 340 requests location information from the GPS module 322 at two different times, and then performs the remaining steps shown in FIG. 4. Safety mode module 340 uses the information identifying the two locations to determine a velocity in step 430 and then compared the determined velocity to a threshold velocity in step 435. If the safety mode module 340 determines in decision step 440 that the velocity does not exceed a defined threshold, step 445 indicates that normal operation resumes (or continues if portable device 10 is not already operating in a safety mode of operation). Alternatively, step 450 indicates that a safety mode of operation is initiated (or continued), as described in one embodiment in more detail in FIG. 5. In one implementation, among others, a memory flag or register value is set to indicate the existence of this safety mode of operation. In another implementation, the lock/unlock module 324 automatically enters a locked mode.

Other embodiments include GPS module 322 and safety mode module 340 being integrated in whole or in part. In one example, there is no safety mode module 340, and GPS module 322 provides the functionality described herein regarding safety mode module 340. In another example, GPS module 322 determines velocity and provides the velocity information to the safety mode module 340. In yet another example, the GPS module further compares determined velocities to a threshold velocity to in turn communicate that state to other modules of portable device 10. Thus, in that example, the steps of FIG. 4 are performed by the GPS module, with steps 450 and 445 being interpreted as communicating the existence or non-existence (or triggers for the beginning and end) of the threshold condition.

FIG. 5 shows one implementation, among others, of steps followed by the portable device 10 during a safety mode of operation. In step 515, it is determined whether user input is received, and when such input is received, the portable device 10 prompts for an override password in step 520, and any resulting user input is evaluated in step 525. In one embodiment, these steps of the process are handled by the lock/unlock module 324. In one implementation of such an embodiment, the prompt (e.g., “Enter Non-Stationary Safety Override Password”) and password are not the same as those used by the lock/unlock module 324 during normal (relatively stationary) operation of the portable device 10, while other implementations use the same prompt and password. In other embodiments, the lock/unlock module 324 is not utilized, and the safety mode module 340 performs steps 510-525.

After the correct password is entered, operation continues in step 530 with the portable device 10 transmitting a notification message that an override password has been input by the user. In one implementation, this notification message is sent as a text message through text messaging module 332 to a defined recipient. In another implementation, among others, the notification message is sent as an email message through email client module 334. Subsequently, interaction with the user continues in step 535, which in some embodiments is in accordance with an altered or limited mode of operation, as discussed above, while other embodiments include resuming normal operation. In the shown embodiment, the portable device 10 will not function until the correct password is entered by the user. Other embodiments include continuing operation with steps 530 and 535, but the notification message may indicate the use of an improper password and/or interaction may be altered accordingly. Other embodiments include deletion of steps 520 and 525.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the herein-described embodiments of the present disclosure are merely possible examples of implementations, merely set forth for a clear understanding of the principles of the disclosure. Any process descriptions or blocks in flow charts should be understood as representing modules, segments, or portions of code which include one or more executable instructions for implementing specific logical functions or steps in the process, and alternate implementations are included in which functions are not be included or executed at all, are executed out of order from that shown or discussed, including substantially concurrently or in reverse order, depending on the functionality involved, as would be understood by those reasonably skilled in the art of the present disclosure. Many variations and modifications are made to the above-described embodiment(s) without departing substantially from the spirit and principles of the present disclosure. Further, the scope of the present disclosure is intended to cover all combinations and sub-combinations of all elements, features, and aspects discussed above. In addition, while many functions and features are disclosed as being in separate embodiments, it should be understood that the present disclosure includes all combinations and sub-combinations of functions disclosed as being in separate embodiments, including user-selectable modes and methods of operation to achieve alternative functions. More generally, all modifications and variations are intended to be included herein within the scope of this disclosure, and all possible claims to individual aspects or combinations of elements or steps are intended to be supported by this disclosure.

I claim:

1. A portable device comprising:
a position determination module that determines positions of the portable device; and
a safety mode module that initiates a safety mode of operation in the portable device responsive to a determination that velocity of the portable device exceeds a defined threshold, wherein velocity is determined based upon changes over time of the determined positions of the portable device.

2. The portable device of claim 1, wherein the safety mode of operation includes the generation and transmission of a notification message to a message recipient indicating operation of the portable device in the safety mode of operation.

3. The portable device of claim 2, wherein the safety mode of operation includes prompting a user of the portable device for an override, and wherein the notification message is sent responsive to receipt of an override from the user of the portable device.

4. The portable device of claim 2, wherein the notification message is sent automatically and independent of any override by a user of the portable device.

5. The portable device of claim 2, wherein the notification message is sent to an automobile insurance server and includes information that can be used to identify an automobile insurance policy.

6. A method comprising:
determining whether velocity of a portable device exceeds a threshold; and
entering a safety mode of operation in the portable device responsive to the velocity of the portable device exceeding a threshold.

7. The method of claim 6, wherein the safety mode of operation includes the generation and transmission of a notification message to a message recipient indicating operation of the portable device in the safety mode of operation.

8. The method of claim 7, wherein the safety mode of operation includes prompting a user of the portable device for an override, and wherein the notification message is sent responsive to receipt of an override from the user of the portable device.

9. The method of claim 7, wherein the notification message is sent automatically and independent of any override by a user of the portable device.

10. The method of claim 7, wherein the notification message is sent to an automobile insurance server and includes information that can be used to identify an automobile insurance policy.
